(19) United States
(12) Patent Application Publication
(10) Pub. No.: US 2024/0309752 A1
(43) Pub. Date: Sep. 19, 2024

(54) DEVICE FOR MEASURING DEFORMATIONS IN A BOREHOLE

(71) Applicants: Centre National De La Recherche Scientifique, Paris 16 (FR); Université de Montpellier, Montpellier (FR)

(72) Inventor: Jean Chery, Saint Clement de Riviere (FR)

(21) Appl. No.: 18/575,159

(22) PCT Filed: Jun. 28, 2022
(86) PCT No.: PCT/FR2022/051293

§ 371 Date: Dec. 28, 2023

(30) Foreign Application Priority Data
Jun. 29, 2021 (FR) FR2106959
Jun. 21, 2022 (FR) FR2206108

(51) Int. Cl. E21B 47/08; E21B 49/00

(52) U.S. Cl. CPC E21B 47/08; E21B 49/006

(57) ABSTRACT

A measuring device for measuring deformation, suitable for being placed in a borehole, comprises: a hollow elastic shell having a diameter compatible with the borehole into which it is inserted; a pressurization system for pressurizing the hollow elastic shell; and uniaxial sensors for measuring the elongation of the hollow elastic shell in at least six different directions.

### CROSS-REFERENCE TO RELATED APPLICATIONS

This application is a national phase entry under 35 U.S.C. § 371 of International Patent Application PCT/FR2022/051293, filed Jun. 28, 2022, designating the United States of America and published as International Patent Publication WO 2023/275489 A1 on Jan. 5, 2023, which claims the benefit under Article 8 of the Patent Cooperation Treaty of French Patent Application Serial No. FR2106959, filed Jun. 29, 2021 and of French Patent Application Serial No. FR2206108, filed Jun. 21, 2022.

### TECHNICAL FIELD

The present disclosure relates to a device for measuring deformations in a borehole. It also relates to a drilling rig comprising the device and to a method of measuring implemented by the device.

### BACKGROUND

All devices for measuring deformations in a borehole are installed vertically during drilling and are mechanically secured with concrete in the casing.

Some of these devices measure only the horizontal volumetric component while other devices measure only the deformation components in the horizontal plane, of which there are three.

Also, there is no device for measuring all the deformation components, of which there are six.

Finally, existing devices do not make it possible to carry out a determination in situ of the mechanical properties of the drilling material and of the surrounding rock.

### BRIEF SUMMARY

One aim of the present disclosure is notably to remedy all or part the aforementioned drawbacks.

To this end, according to a first aspect of the present disclosure, a device is proposed for measuring deformations suitable for being arranged in a borehole, comprising: a hollow elastic shell having a diameter compatible with the borehole into which it is inserted; a system for pressurizing the hollow elastic shell; uniaxial sensors arranged inside the hollow elastic shell for measuring the elongation of the hollow elastic shell in at least six different directions.

The uniaxial sensors can be provided with ends anchored in the hollow elastic shell.

The hollow elastic shell may be of spherical shape.

Advantageously, the hollow elastic shell may have homogeneous elastic properties and a moderate coefficient of thermal expansion.

For example, the hollow elastic shell may be made of fiber-reinforced concrete or polycarbonate. Preferably, the hollow elastic shell is made of a monolithic material.

According to one embodiment, the pressurizing system comprises a tube extending from the surface of the borehole to the interior of the hollow elastic shell.

The uniaxial sensors can be formed from deformable systems whose ends are attached (bonded or anchored) onto the hollow elastic shell in order to ensure a secure coupling.

The deformable systems may be displacement amplifiers, two opposite vertices of which, located on the major axis of the parallelogram, are attached to the hollow elastic shell.

Advantageously, the major axes of the uniaxial systems are parallel to the edges of a regular tetrahedron.

The device according to the first aspect of the present disclosure may further comprise a contactless measuring device arranged to measure the refractive index of the environment.

The contactless measurement device may be of the capacitive or optical type.

The device according to the first aspect of the present disclosure may further comprise a communication device provided to transmit the measurements from the contactless measuring device to the surface of the borehole.

According to a second aspect of the present disclosure, a drilling rig is proposed comprising a measuring device according to the first aspect of the present disclosure, or one or more of its improvements.

According to a third aspect of the present disclosure, a method is proposed for measuring deformations in a borehole, implemented in a drilling rig according to the second aspect of the present disclosure, comprising an initial step of pressurizing the elastic shell and a step of measuring the variations of the elongations of each of the uniaxial sensors of the measuring device of the drilling rig, relative to a reference elongation measured during a calibration step.

The method according to the third aspect of the present disclosure may comprise a calibration step during which the reference elongation is measured for each of the uniaxial sensors.

The method may further comprise a step of determining the evolution of mechanical properties in the borehole by measuring the variation of the elongations of each of the uniaxial sensors and then a comparison with the isotropy, after a pressure increment inside the hollow elastic shell via the system for pressurizing the hollow elastic shell.

### BRIEF DESCRIPTION OF THE DRAWINGS

Other advantages and particularities of the present disclosure will become apparent on reading the detailed description of implementations and embodiments, which are in no way exhaustive, with reference to the appended drawings, in which:

FIG. 1 shows a schematic sectional view of an embodiment of a drilling rig according to the present disclosure;

FIG. 2 shows a schematic sectional view of an embodiment of a measuring device according to the present disclosure equipping the drilling rig shown in FIG. 1;

FIG. 3 shows a perspective view of a second embodiment of a measuring device according to the present disclosure equipping the drilling rig shown in FIG. 1;

FIG. 4 shows a schematic sectional view of a third embodiment of a measuring device according to the present disclosure equipping the drilling rig shown in FIG. 1;

FIG. 5 shows a schematic view of a deformable system implemented in a device shown in FIG. 2;

FIG. 6 shows an embodiment of a method for measuring deformations at a borehole, implemented in the drilling rig shown in FIG. 1; and

FIG. 7 describes a method for determining a configuration of the exploded tetrahedron.

### DETAILED DESCRIPTION

Since the embodiments described below are in no way limiting, it will be, in particular, possible to consider variants of the present disclosure comprising only a selection of the features described, subsequently isolated from the other features described, if this selection of characteristics is sufficient to confer a technical advantage or to differentiate the present disclosure from the prior art. This selection comprises at least one feature, preferably functional, without structural details, or with only a portion of the structural details if this part only is sufficient to confer a technical advantage or to differentiate the present disclosure from the prior art.

In the figures, an element appearing in several figures retains the same reference.

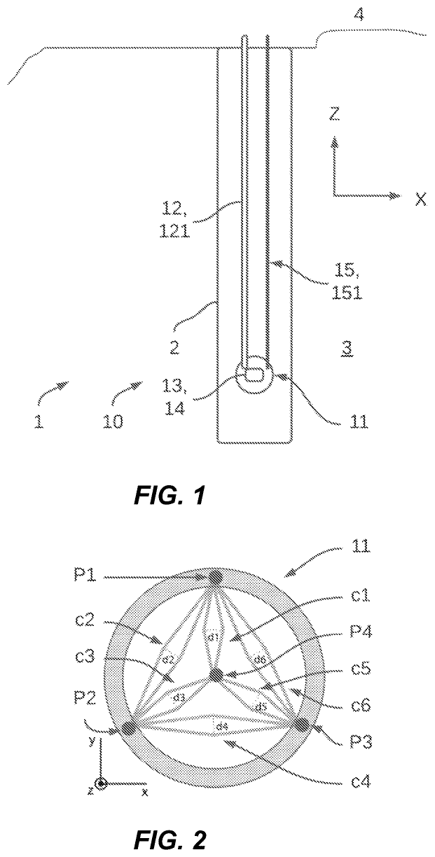

With reference to FIG. 1, a schematic sectional view is shown of a drilling rig 1 according to one embodiment of the present disclosure. The cross-section is made along a horizontal axis X and a vertical axis Z.

The drilling rig 1 comprises, in particular, a borehole 2 made in a casing 3, extending from a surface 4 along the vertical axis Z. The borehole 2 must be filled with a rigid and slightly compressible body. It may be, for example, concrete or filled with glass or silica beads, of millimetric diameter.

The drilling rig 1 is equipped with a measuring device 10 according to the present disclosure.

The measuring device 10 comprises a hollow elastic shell 11, preferably of the sphere type, which has a diameter compatible with the borehole 2 in which it is inserted. Alternatively, the hollow elastic shell may be of the ellipsoid type, or of the cylinder type.

The outside diameter of the hollow elastic shell has a value in the range of 15 cm to 30 cm.

The hollow elastic shell may have an elastic inner wall. The thickness of the wall is determined to allow a measurable deformation in response to the forces exerted by the casing 3. The thickness of the inner wall may be on the order of 1 to 2 cm.

The hollow elastic shell may have isotropic or substantially isotropic mechanical properties.

More precisely, the elastic inner wall is formed from polystyrene immediately enveloping the inner volume of the hollow elastic shell.

A second elastic annular thickness, which may be made of metal, of preferably low-shrinkage fiber-reinforced concrete, or of polycarbonate, forms another part of the hollow elastic shell by surrounding the elastic inner wall. More generally, the second elastic annular thickness can be made with any resistant material having homogeneous elastic properties and a moderate coefficient of thermal expansion, such as that of concrete. Thus, the hollow elastic shell may be made of a monolithic material.

The coefficient of thermal expansion may be less than 10⁻⁵ C^{o-1}.

The measuring device 10 further comprises a system 12 for pressurizing the hollow elastic shell 11.

The pressurizing device 12 has several functions: in the laboratory, transient pressurization makes it possible to calibrate the six uniaxial sensors, to verify the deformation isotropy of the sphere, and to calculate its elastic properties; in drilling, the transient pressurization and the response of the six sensors make it possible to evaluate the elastic properties of the surrounding medium; at a great depth, the continuous pressurization makes it possible to compensate for the weight of the earth and to retain the hollow spherical shell with regard to elastic deformations.

The pressurizing system 12 may comprise, for example, a metal tube 121 extending from the surface 4 into the hollow spherical shell 11. On the surface 4, the metal tube can be, for example, connected to a pressurizing cylinder equipped with a pressure gage and a control valve (not shown).

The measuring device 10 further comprises uniaxial sensors 13 for measuring the elongation of the sphere in six different directions. More precisely, the deformation measurement can be carried out by a Fabry-Pérot nanometric-resolution optical fiber end interferometer.

As shown in FIG. 2, the uniaxial sensors 13 can be formed from deformable systems with flexible joints c1, c2, c3, c4, c5, c6 whose ends are attached to the sphere 11. In the example shown, the deformable systems with flexible joints c1, c2, c3, c4, c5, c6 measure, respectively, the elongations d1, d2, d3, d4, d5, d6. Rigid systems for optical or capacitive measurement could also be used to measure the variations in deformation. These deformable systems are called flexural hinges in the scientific literature, which may result in a structure with flexible joints.

The deformation of the hollow elastic shell 11 is determined from the measurement of the transverse elongations d1, d2, d3, d4, d5, d6 from mathematical formulae corresponding to the inversion of a 6×6 linear system. This system comprises as data the orientation vectors of uniaxial sensors and longitudinal elongations of the detectors, and, as unknowns, the 6-component strain tensor. It is possible to add redundancy by adding uniaxial sensors. The measurement of the transverse elongations makes it possible to first calculate the longitudinal elongations, then the six components of the strain tensor of the hollow elastic shell.

In the example shown, the deformable systems c1, c2, c3, c4, c5, c6 are deformation amplifiers, two opposite vertices of which, located on the major axis, are attached to the sphere at points P1, P2, P3 and P4, the points P1, P2, P3 and P4 forming a regular tetrahedron of the sphere 11 for the given example, whose face P1, P2 and P3 is inscribed in the plane X-Y, the base X, Y, Z being a direct orthogonal. The deformable systems make it possible to transversely amplify the longitudinal displacements applied at the ends, which increases the resolution of the measurement.

The spherical shape allows an optimal orientation of the uniaxial sensors. For example, the directions of the edges of a regular tetrahedron make it possible to sample the three-dimensional deformation of a small volume in an optimal manner.

The choice of the materials used for the amplifiers is important, since any deformation of the sphere, regardless of thermal or mechanical origin, will be amplified by a factor of between 10 to 30 before being measured by the optical system.

It is therefore of great benefit to have a material that is the least expandable possible, so that the measurements exclusively take into account the deformation of mechanical origin.

The coefficients of expansion of the materials that can be used to construct the amplifiers are:
Aluminum: 26×10⁻⁶ K⁻¹
Steel: 11×10⁻⁶ K⁻¹
Invar: 1.0×10⁻⁶ K⁻¹
Borosilicate glass: 3.3×10⁻⁶ K⁻¹
Silica glass: 0.6×10⁻⁶ K⁻¹
ZERODUR® glass-ceramic: 0.02×10⁻⁶ K⁻¹

The first laboratory amplifier was machined in aluminum. Since glasses and ceramics are tricky to machine due to their fragility, it therefore appears especially beneficial to use the ZERODUR®, an ultra-stable material on a thermal plane (1300 times less expandable than aluminum).

In the example shown, the major axes of the sensors form in pairs an arccos angle (1/3), that is to say 70.529 degrees. The amplification factor between the longitudinal deformation, imposed by the sphere, and the measured transverse deformation, can vary between 10 and 30 depending on the devices used.

Again referring to FIG. 2, each of the parallelograms of the deformable systems c1, c2 and c6 has a vertex attached to the point P1, each of the parallelograms of the deformable systems c2, c3 and c4 has a vertex attached to the point P2, and each of the parallelograms of the deformable systems c4, c5 and c6 has a vertex attached to the point P3. The vertices of the parallelograms of the deformable systems c1, c3 and c5 that are opposite the points P1, P2, P3 are attached at the point P4.

As can be seen in FIG. 2, the points P1, P2, P3 are provided with ends that are anchored in the hollow elastic shell 11.

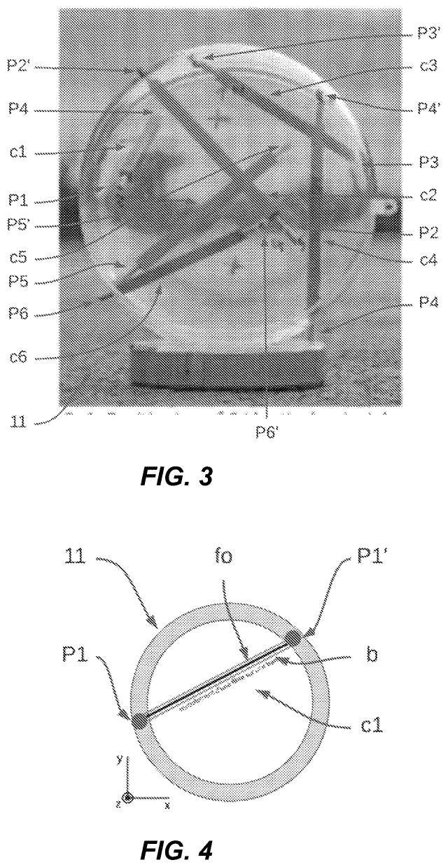

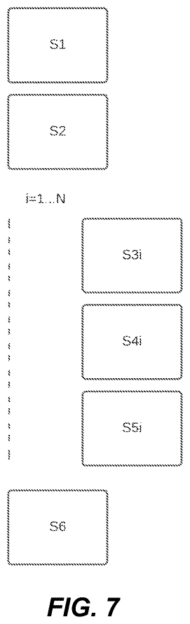

FIG. 3 shows another arrangement of deformable systems within the hollow elastic shell 11 wherein the deformable systems c1, c2, c3, c4, c5 and c6 are placed differently on an exploded tetrahedron, which requires 12 anchoring points, respectively, P1 and P1′, P2 and P2′, P3 and P3′, P4 and P4′, P5 and P5′, P6 and P6′, instead of 4 anchoring points. Here again, the edges c1 and c4, c2 and c5, c3 and c6 are orthogonal in pairs. A method for determining a configuration of the exploded tetrahedron will be described with reference to FIG. 7.

FIG. 4 shows yet another embodiment, wherein the deformable systems, for example, the system c1, comprise a pressure-deformable bar b on which an optical fiber fo is wound with a large number of turns. The deformation of the sphere 11 generates a variation in length between the anchoring points P1, P1′, which causes a tension/compression of the fiber measurable by interferometry. At least 6 systems of this type must be installed, in directions parallel to those of the edges of a regular tetrahedron, in order to calculate the tensor of the deformations associated with the sphere.

The measuring device 10 further comprises a contactless measuring device 14 arranged for measuring the variations of the optical path in the absence of elongation. This optical measuring device makes it possible to correct the measurements of variations in transverse distances d1, d2, d3, d4, d5, d6 of the variations in refractive index.

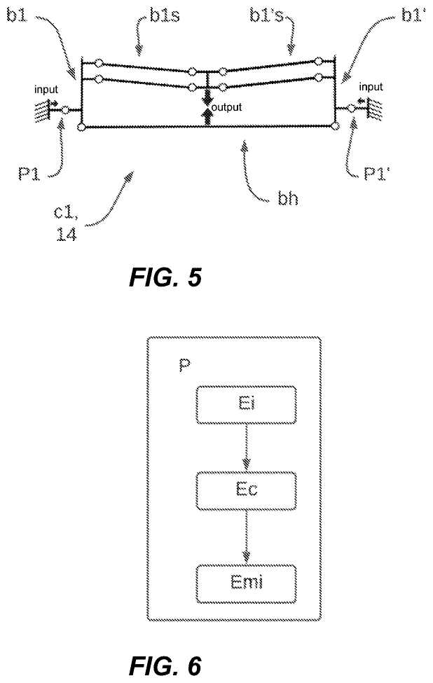

As shown in FIG. 5, the contactless measuring device 14 associated with the system c1 has a topology based on a symmetrical structure with five rigid bars bh, b1, b1′, b1s, b1's, for the amplification of the displacement, and a flexible mechanism is implemented for the amplifier. In the literature, this type of mechanical amplifier is called a compliant mechanical amplifier or CMA. The contactless measuring device 14 may reach a large amplification ratio and a high natural frequency, relative to the other topologies.

The circles represent the flexible joints, the bars the rigid parts. The application of an axial compression/extension input (horizontal arrows outside the device) at the anchoring points P1, P1′, generates a transverse deformation at the output proportional to the input deformation, but amplified (vertical arrows).

The contactless measuring device 14 also conventionally comprises a collimator connected to an optical fiber and oriented to measure the variations in distance at the output, the output being arranged between an angle mirror placed at the center of the bar bh at one end of the output space and arranged on the optical path of the collimator, and a planar mirror arranged at the other end of the output space on the optical path of the collimator.

The measuring device 10 further comprises a communication device 15 (FIG. 1) provided to communicate the measurements of the contactless measuring device to the surface of the borehole. The communication device 15 comprises, for example, a sealed data acquisition cable 151 extending from the surface 4 into the sphere 11 where it is connected to the measuring device 10.

FIG. 6 shows an embodiment of a method P for measuring deformations in a borehole, implemented in a drilling rig 1 according to the present disclosure.

The measuring method P comprises:
an initial step Ei of pressurizing the sphere of the measuring device,
a calibration step Ec of measuring the elongations of each of the uniaxial sensors of the measuring device 10 of the drilling rig 1, during which a reference elongation is measured for each of the uniaxial sensors, and
one or more steps Emi of measuring the variations of the elongations of each of the uniaxial sensors, relative to a reference elongation measured during a calibration step.

The measuring device according to the present disclosure makes it possible to measure the strain tensor in the borehole with an accuracy on the order of 10\hat{ }-9 (one nanometer per meter), which is useful for geophysical applications in the field of geological reservoirs, volcanoes, faults, and in the field of civil engineering.

The present disclosure further proposes an active method for in situ determination of the properties of the assembly formed by the sphere, the borehole filled with concrete, and the casing. Indeed, a borehole strain sensor must make it possible to measure the “ideal” deformation that the earth's crust would undergo in the absence of disturbance, such as that of a borehole in which the measuring apparatus is located. This is not possible directly.

To access this information, a corrective term must be subtracted from the measurement, which is a deformation model representing the heterogeneity of the subsoil.

Normally this is done by using an ideal geophysical model associated with the terrestrial tides. By comparing this ideal model over several days to the measurement, it is possible to determine the corrective term, which raises numerous problems related to the inaccuracy of the geophysical model, influenced by the topography, the ocean tides, and the pressure fluctuations.

The present disclosure proposes a direct and precise method of measuring for determining in situ the evolution of mechanical properties at the borehole by measuring the variation of the elongations of each of the uniaxial sensors 13 and then comparing with the isotropy, after pressure increment inside the sphere of the measuring device by way of the pressurizing system of the sphere. Indeed, if the sphere, the concrete fill of the borehole and the casing rock formed a homogeneous medium, the expansion measured by the six uniaxial sensors in response to the overpressure should be isotropic. The deviation from isotropy is related to the contrasts of elastic properties between the fill of the borehole and the casing. Using the six elongation measurements, the contrasts can be exactly estimated by a finite element mechanical model. This model, taking into account the exact geometry of the borehole and the sphere, makes it possible to determine the ratios of the elastic properties between the fill of the borehole and the casing. As the contrasts of properties are determined, it is then possible to go back from the true measurement to the ideal measurement of the deformation in a homogeneous medium.

Furthermore, the measurement after pressure increment makes it possible to estimate the slow change in the properties of the concrete fill of the borehole, which is essential in order to precisely estimate the deformation of the crust over long periods of time, months or years.

FIG. 7 describes a method for determining a configuration of the exploded tetrahedron. Step S1 comprises the information about the variable length L of the six bars. Step S2 initializes an inter-bar distance variable Dib to 0: Dib=0.

A loop of the variable i, i=1 to i=N, for example, N=1000000 then begins in this loop.
Step S3i performs a random selection of 6 positions on contact circles (0 to 2pi): the contact circles are defined as the place of contact between the sphere and a segment of fixed orientation. The contact points are defined, for example, by selecting a random angle (0-2pi) on the contact circles for each of the 6 segments.
Step S4i performs a calculation of the minimum of 15 distances between bars, this minimum being stored in the variable Dmin.
During step S5i, if the variable Dmin is greater than the variable Dib, then the variable Div stores the value of the variable Dmin: If Dmin>Dib, Dib=Dmin.
End of loop.

Step S6 proposes writing the optimal configuration, that is to say the one that corresponds to the greatest distance between bars. The distance between two bars is defined as the minimum of the distance between two points of the two bars.

Of course, the present disclosure is not limited to the examples that have just been described and numerous modifications can be made to these examples without departing from the scope of the invention as defined by the claims. In addition, the different features, forms, variants and embodiments of the present disclosure may be associated with one another in various combinations insofar as they are not incompatible or exclusive of one another.

1. A measuring device for measuring deformations suitable for being arranged in a borehole, the device comprising:
a hollow elastic shell having a diameter compatible with the borehole;
a system for pressurizing the hollow elastic shell; and
uniaxial sensors arranged within the hollow elastic shell to measure the elongation of the hollow elastic shell in at least six different directions.

2. The measuring device of claim 1, wherein ends of the uniaxial sensors are anchored in the hollow elastic shell.

3. The measuring device of claim 2, wherein the hollow elastic shell is spherical in shape.

4. The measuring device of claim 1, wherein the hollow elastic shell has homogeneous elastic properties and a moderate coefficient of thermal expansion.

5. The measuring device of claim 4, wherein the hollow elastic shell comprises fiber-reinforced concrete or polycarbonate.

6. The measuring device of claim 1, wherein the hollow elastic shell comprises a monolithic material.

7. The measuring device of claim 1, wherein the system for pressurizing the hollow elastic shell comprises a tube extending from outside the hollow elastic shell to the interior of the hollow elastic shell.

8. The measuring device of claim 1, wherein the uniaxial sensors comprise displacement amplifiers, two opposite vertices of each of which are located on a major axis of a parallelogram and are attached to the hollow elastic shell.

9. The measuring device of claim 1, wherein the uniaxial sensors are parallel to the edges of a regular tetrahedron.

10. The measuring device of claim 1, further comprising a contactless measuring device arranged to measure a refractive index of an environment.

11. The measuring device of claim 10, wherein the contactless measuring device comprises a capacitive sensor or an optical sensor.

12. The measuring device of claim 10, further comprising a communication device provided to communicate measurements from the contactless measuring device to a surface of the borehole.

13. A drilling rig comprising a measuring device according to claim 1.

14. A method for measuring deformations at a borehole, comprising:
providing a measuring device including:
a hollow elastic shell having a diameter compatible with the borehole;
a system for pressurizing the hollow elastic shell; and
uniaxial sensors arranged within the hollow elastic shell to measure the elongation of the hollow elastic shell in at least six different directions;
pressurizing the hollow elastic shell; and
measuring variations of elongations of each of the uniaxial sensors of the measuring device relative to a reference elongation measured during a calibration step.

15. The deformation measurement method of claim 14, further comprising calibrating the measuring device to measure the reference elongation for each of the uniaxial sensors.

16. The method of claim 14, further comprising determining an evolution of mechanical properties at the borehole by measuring a variation of elongations of each of the uniaxial sensors and then comparing with an isotropy, after incrementally changing a pressure inside the hollow elastic shell of the measuring device using the system for pressurizing the hollow elastic shell.

17. The measuring device of claim 1, wherein the hollow elastic shell is spherical in shape.

18. The measuring device of claim 4, wherein the hollow elastic shell has a coefficient of thermal expansion of less than 10⁻⁵ C^{o-1}.

19. The measuring device of claim 3, wherein the hollow elastic shell comprises a monolithic material.

20. The measuring device of claim 3, wherein the uniaxial sensors comprise displacement amplifiers, two opposite vertices of each of which are located on a major axis of a parallelogram and are attached to the hollow elastic shell.
